(19) United States
(12) Patent Application Publication
(10) Pub. No.: US 2011/0102527 A1
(43) Pub. Date: May 5, 2011

(54) CARRIAGE DEVICE OF INK JET RECORDING APPARATUS AND INK JET RECORDING APPARATUS HAVING THE SAME

(75) Inventors: Takayuki TAMAKI, Shiojiri-shi (JP); Kazuyuki KAGAMI, Shiojiri-shi (JP); Satoru MIURA, Matsumoto-shi (JP)

(73) Assignee: SEIKO EPSON CORPORATION, Tokyo (JP)

(21) Appl. No.: 12/913,356

(22) Filed: Oct. 27, 2010

(30) Foreign Application Priority Data
Oct. 29, 2009 (JP) 2009-248535

(51) Int. Cl. B41J 2/01

(52) U.S. Cl. 347/102

(57) ABSTRACT

Ink jet recording apparatus carriage device which discharges light cure type ink onto a recording medium while moving along a first guide shaft and a second guide shaft, which are disposed parallel to each other, curing the discharged ink by light, thereby forming a desired image on the recording medium, includes: head unit having recording head which discharges the ink onto the recording medium and recording carriage on which the recording head is mounted; light curing unit having a plurality of light curing sections which cures the ink on the recording medium by light and light curing carriage on which the plurality of light curing sections are mounted; carriage base slidably supported on the first guide shaft; and support frame having one end fixed to the carriage base and the other end slidably supported on the second guide shaft, wherein the head unit is supported in a cantilever manner on the carriage base.

### BACKGROUND

1. Technical Field

The present invention relates to a carriage device of an ink jet recording apparatus which forms an image on a recording medium by discharging light cure type ink onto the recording medium with use of an ink jet type recording head and irradiating the ink landed on the recording medium with light, thereby curing the ink, and an ink jet recording apparatus having the carriage device.

2. Related Art

In the past, an ink jet recording apparatus has been known which has a carriage on which a plurality of ink jet heads and a pair of scan type ultraviolet irradiation devices are mounted, a movement mechanism (a motor and the like) which moves the carriage in a main scanning direction along a guide rail, and a non-scan type ultraviolet irradiation device which faces a transport pathway of a recording medium and irradiates the recording medium after image formation with ultraviolet, and forms an image by discharging ultraviolet cure type ink from the ink jet head onto the recording medium while moving the carriage in the main scanning direction (refer to JP-A-2008-168502). This ink jet recording apparatus is made such that a plurality of recording heads and a pair of scan type ultraviolet irradiation devices are mounted on an end of one side of the carriage and an end of the other side of the carriage is supported on the guide rail so that the carriage can reciprocate along the guide rail.

However, in the above-mentioned ink jet recording apparatus, the center of gravity of the carriage (a carriage device) is located at a portion in which the ink jet heads (the recording heads) and the scan type ultraviolet irradiation devices (light curing sections) are disposed. That is, since the carriage device is supported in a cantilever manner on the guide rail at a position distant from its center of gravity, there is a fear that when starting movement along the guide rail (and stopping the movement), a free end side of the carriage device vibrates due to inertia, so that a misalignment occurs in a landing position of ink discharged from the recording head.

### SUMMARY

An advantage of some aspects of the invention is that it provides a carriage device of an ink jet recording apparatus, in which vibration at the time of movement is suppressed, so that a misalignment of a landing position of the discharged light cure type ink is prevented, and an ink jet recording apparatus having the carriage device.

According to a first aspect of the invention, there is provided a carriage device of an ink jet recording apparatus which discharges light cure type ink onto a recording medium while moving along a first guide shaft and a second guide shaft, which are disposed parallel to each other, and cures the discharged ink by light, thereby forming a desired image on the recording medium, the carriage device including: a head unit having a recording head which discharges the ink onto the recording medium and a recording carriage on which the recording head is mounted; a light curing unit having a plurality of light curing sections which cures the ink on the recording medium by light and a light curing carriage on which the plurality of light curing sections are mounted; a carriage base slidably supported on the first guide shaft; and a support frame having one end fixed to the carriage base and the other end slidably supported on the second guide shaft, wherein the head unit is supported in a cantilever manner on the carriage base.

In this case, it is preferable that the head unit and the light curing unit be disposed between the first guide shaft and the second guide shaft.

Also, it is preferable that a plurality of the recording heads be provided, the plurality of recording heads be grouped into a plurality of recording sections and mounted on the recording carriage, and the plurality of recording sections be disposed in the order of the recording sections having a smaller number of the mounted recording heads in a direction away from the first guide shaft.

According to these configurations, the head unit is supported in a cantilever manner on the carriage base supported at both sides. That is, it is possible to support the carriage device while dispersing the overall weight thereof to the first guide shaft and the second guide shaft. By this, the whole of the carriage device can be maintained in a stable position without vibrating at the time of the starting of the movement and the time of the stopping of the movement, so that the movement can be stabilized.

Also, by supporting the head unit in a cantilever manner, it is possible to accurately and easily perform gap adjustment or parallelism adjustment which is particular to the head unit. Moreover, in the head unit, since the recording section in which the number of the mounted recording heads is large is provided on the first guide shaft side, stable movement where influence of inertia is small becomes possible, so that vibration due to inertia at the time of the starting of the movement and the time of the stopping of the movement can be prevented. By this, since shaking or overrunning of the recording carriage (a plurality of recording sections) can be suppressed, so that a misalignment does not occur in a landing position of ink on the recording medium, highly-precise image formation becomes possible.

In this case, it is preferable that the plurality of light curing sections be located on both outer sides in a movement direction of each of the recording sections.

According to this configuration, in a case where the carriage device (each recording section) performs reciprocating movement, immediately after ink is discharged at the time of forward movement, it is possible to perform light-curing of the ink by the light curing section. Furthermore, it is also possible to perform only the discharging of ink at the time of forward movement and perform the light curing at the time of backward movement. By this, it is possible to flexibly control the time before the light curing of ink, so that it is possible to arbitrarily set surface roughness of an image which is formed. On the other hand, if light curing is performed immediately after ink is landed on the recording medium, a surface becomes rough.

Also, in this case, it is preferable that each of the light curing sections perform semi-curing of the ink to a surface cured state, and the light curing unit further include a main curing section which is mounted on the light curing carriage and performs main curing of the ink after the semi-curing.

According to this configuration, first, by performing the semi-curing of ink, it becomes possible to control the degree of wetting and spreading of ink droplets on the recording medium. Also, since ink on the recording medium is in a semi-cured sate, even a short time of light irradiation for the main curing is enough. Also, by making the main curing section be movable, the main curing section can be constituted as a small size, and it is possible to reliably fix the formed (drawn) image to the recording medium.

In this case, it is preferable that the carriage device further include a head gap adjustment section which is interposed between the carriage base and the head unit and adjusts a gap of the head unit with respect to the recording medium; and a parallelism adjustment section which adjusts parallelism of the head unit with respect to the recording medium.

According to this configuration, it is possible to appropriately change the gap between each recording head and the recording medium in accordance with the thickness or the like of the recording medium by the head gap adjustment section. Also, by the parallelism adjustment section, it is possible to maintain in a parallel fashion the respective recording heads mounted on the head unit and also make parallelism of each recording head uniform. By this, since each recording head can face the recording medium in a parallel fashion with an appropriate gap, it is possible to perform optimum ink discharging, so that a highly-precise image can be formed on the recording medium.

In this case, it is preferable that the light curing unit be suspended from and supported on the support frame through a plurality of pieces of strut members distributed over the entire area of the light curing unit.

According to this configuration, the light curing carriage can be prevented from being distorted (thermally deformed) due to heat generated from each light curing section (and the main curing section). Therefore, it is preferable that each strut member be disposed in the vicinity of each light curing section or the like. By this, each light curing section and the like can be stably held at the light curing carriage in an appropriate position and irradiate given light to ink on the recording medium, so that the ink on the recording medium can be appropriately cured.

According to a second aspect of the invention, there is provided an ink jet recording apparatus including: the above-described carriage device of the ink jet recording apparatus; and a movement section which moves the carriage device in a main scanning direction along a first guide shaft and a second guide shaft and moves a recording medium in a sub-scanning direction.

According to this configuration, since the carriage device which allows vibration due to inertia at the time of the starting of the movement and the time of the stopping of the movement to be prevented is mounted, shaking or overrunning of the recording carriage is suppressed, so that highly-precise image formation having no misalignment in a landing position of ink on the recording medium becomes possible.

### BRIEF DESCRIPTION OF THE DRAWINGS

The invention will be described with reference to the accompanying drawings, wherein like numbers reference like elements.

FIGS. 1A and 1B are a plan view and a side view, which schematically show the inside of an ink jet recording apparatus related to an embodiment (a first embodiment).

FIGS. 2A and 2B are a plan view and a side view of a carriage device.

FIG. 3 is a plan view schematically showing a head unit and a light curing unit of the carriage device.

FIGS. 4A and 4B are front and rear perspective views schematically showing a recording head.

FIGS. 5A and 5B are a front view and a side view of a recording carriage and a carriage base.

FIGS. 6A and 6B are a plan view and a side view of the carriage device and FIG. 6C is a partly enlarged view of a light gap adjustment section.

FIG. 7 is a flow chart of an image forming method related to the embodiment.

FIGS. 8A to 8E are explanatory views (side views) schematically showing states in which a visible image, a non-visible image, and a coat layer are formed in the image forming method related to the embodiment.

FIGS. 9A to 9C are explanatory views (plan views) schematically showing states in which the visible image, the non-visible image, and the coat layer are formed in the image forming method related to the embodiment.

### DESCRIPTION OF EXEMPLARY EMBODIMENTS

Hereinafter, an ink jet recording apparatus related to embodiments of the invention will be described with reference to the accompanying drawings. This ink jet recording apparatus is to form (draw) an image on a recording medium by discharging ultraviolet cure type ink from a recording head onto the recording medium, and then irradiating ultraviolet rays from an ultraviolet irradiator, thereby curing the ultraviolet cure type ink landed on the recording medium.

### First Embodiment

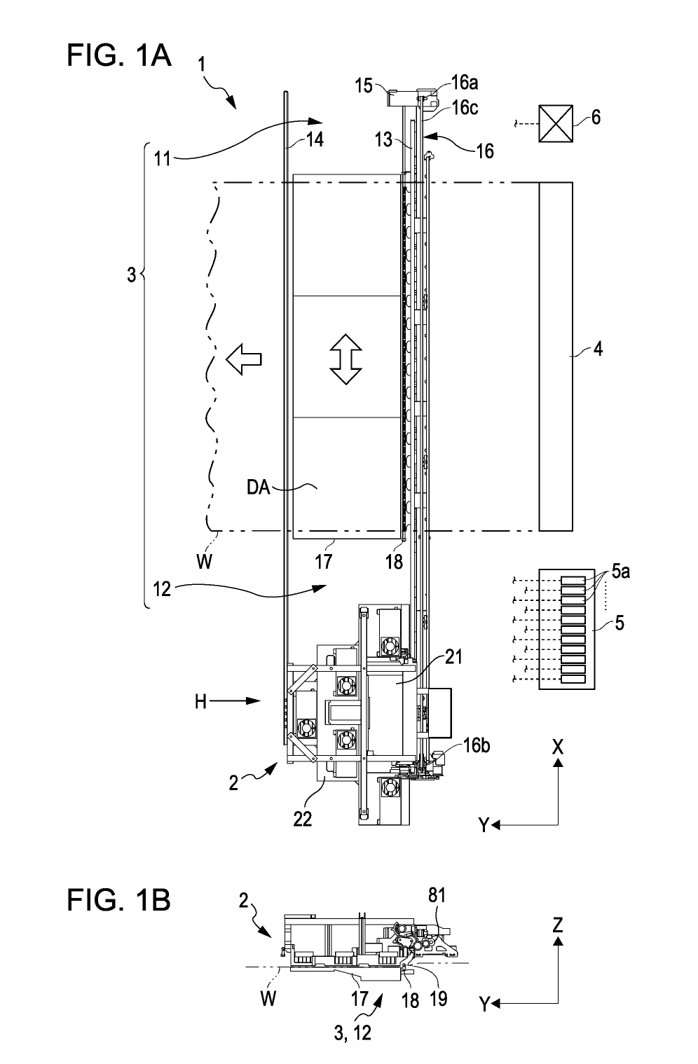

As shown in FIGS. 1A and 1B, an ink jet recording apparatus 1 is provided in an outer casing (not shown) thereof with a carriage device 2 on which a head unit 21 having a plurality of ink jet type recording heads 30 and a light curing unit 22 are mounted; a movement section 3 which relatively moves the carriage device 2 and a recording medium W; a medium supply section 4 in which the recording medium W before drawing is set; an ink supply section 5 which supplies ultraviolet cure type ink (hereinafter referred to as “ink”) of a plurality of colors to the plurality of recording heads 30; and a control section 6 which controls an image forming process by the ink jet recording apparatus 1.

Also, although it is not shown, a maintenance section for preventing nozzle clogging or the like of each recording head 30 is disposed on the home position H side (the lower side in FIG. 1A) of the carriage device 2. The maintenance section includes a capping unit which seals a nozzle forming face of each recording head 30, a suction unit which forcibly sucks ink from each recording head 30, and a wiping unit which wipes the face of each recording head 30, in which nozzle orifices 36 are formed.

As shown in FIGS. 1A and 1B, the movement section 3 includes a head moving mechanism 11 which moves the carriage device 2 in a main scanning direction (hereinafter referred to as an “X-axis direction”), and a medium feed mechanism 12 which moves the recording medium W in a sub-scanning direction (hereinafter referred to as a “Y-axis direction”), thereby feeding the recording medium W to a position (a drawing area DA) which faces the carriage device 2.

The head moving mechanism 11 includes a first guide shaft 13 and a second guide shaft 14, which support the carriage device 2 so as to be able to freely move in the X-axis direction, a servomotor 15 which is a driving source that moves the carriage device 2, and a belt transmission mechanism 16 which transmits the rotation power of the servomotor 15 to the carriage device 2, thereby reciprocating the carriage device 2 in the X-axis direction.

The belt transmission mechanism 16 includes a driving pulley 16a which is disposed at an end portion of one side in the X-axis direction connected to the servomotor 15, a driven pulley 16b which is disposed at an end portion of the other side in the X-axis direction, and an endless timing belt 16c which is mounted to pass around the driving pulley 16a and the driven pulley 16b. A base portion of the carriage device 2 is connected to one place of the timing belt 16c through a belt fixing portion 62 which will be described later, whereby, if the servomotor 15 rotates normally or in reverse, the carriage device 2 reciprocates in the X-axis direction through the timing belt 16c.

The first guide shaft 13 is a shaft with an upper portion formed into a semicircular shape in cross section and is disposed on the upstream side in the Y-axis direction of the drawing area DA so as to cross the recording medium W which is supplied to the drawing area DA, in a width direction (the X-axis direction). Although it is not shown, the first guide shaft 13 is supported on an apparatus frame (not shown) by a plurality of support members in an extending direction thereof, so that the bending thereof in the up-down direction is prevented. In the same way, the second guide shaft 14 is a shaft having an approximately rectangular shape in cross section and is disposed on the downstream side in the Y-axis direction of the drawing area DA so as to be parallel to the first guide shaft 13. The lengths of the first guide shaft 13 and the second guide shaft 14 are set in accordance with the largest width of the recording medium W which can be supplied. Then, the carriage device 2 is supported on the base portion side thereof by the first guide shaft 13 and on the leading end side thereof by the second guide shaft 14 and guided by the first guide shaft 13 and the second guide shaft 14, thereby reciprocating in the X-axis direction.

The servomotor 15 can perform position control in the X-axis direction of the carriage device 2 and is disposed on the side (the upper side in FIG. 1A) opposite to the home position H of the carriage device 2 such that a driving shaft thereof faces the upstream side in the Y-axis direction. By the normal and reverse rotation driving of the servomotor 15, the carriage device 2 reciprocates along the first guide shaft 13 and the second guide shaft 14 through the timing belt 16c. Then, the servomotor 15 performs control such that the speed of the carriage device 2 which moves in the X-axis direction on the recording medium W (the drawing area DA) becomes a constant speed.

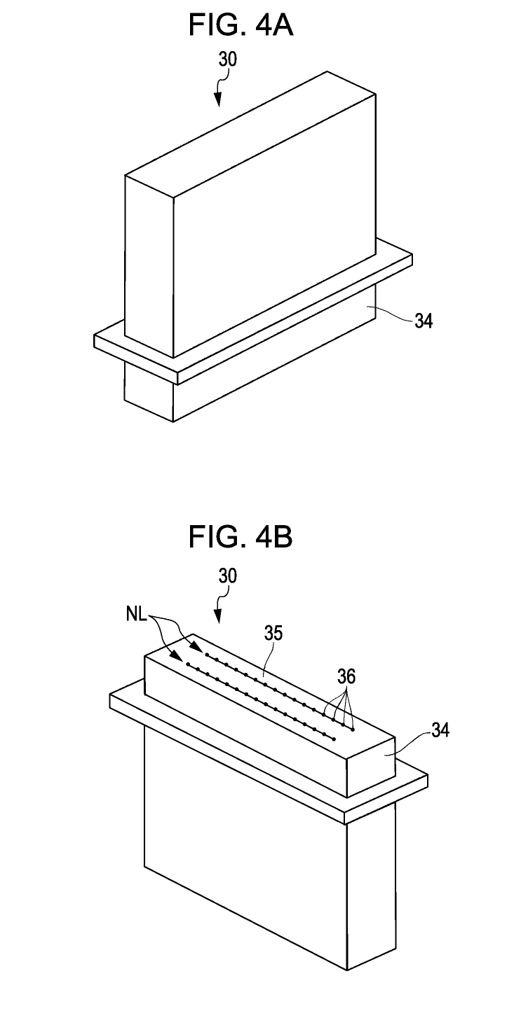

The medium feed mechanism 12 includes a platen 17 which supports the recording medium W from the back face (non-recording face) side, a feed roller 18 which comes into contact with the back face of the recording medium W, thereby feeding the recording medium W in the Y-axis direction, a medium pressing roller 19 (refer to FIG. 1B) which comes face to face with the feed roller 18 with the recording medium W interposed therebetween, and a feed motor (not shown) which rotates the feed roller 18, thereby intermittently feeding the recording medium W. In addition, the recording medium W is intermittently fed with a dimension corresponding to the length of a nozzle row NL (refer to FIG. 4B) of the recording head 30 as one pitch.

In the surface of the platen 17, a plurality of small holes (not shown) is formed in a matrix form (or in a zigzag form) so as to penetrate toward the back face, and below the platen 17, a suction fan (not shown) is provided. By the rotational driving of the suction fan, suction power acts on the recording medium W on the platen 17 through the plurality of small holes, so that the recording medium W is positioned and fixed having a uniform flatness on the platen 17. In this way, since a drawing process is performed with respect to the recording medium W having no distortion, a highly-precise image formation in which there is no misalignment in a landing position of ink becomes possible.

The feed roller 18 and the medium pressing roller 19 are located below the first guide shaft 13, that is, on the upstream side in the Y-axis direction of the drawing area DA. The medium pressing roller 19 is a driven roller which rotates in accordance with the transport of the recording medium W by the rotation of the feed roller 18, and presses down the recording medium W on the feed roller 18 from above. That is, the feed roller 18 and the medium pressing roller 19 are constituted by nip rollers which are composed of a driving roller and a driven roller, respectively, and feed the recording medium W at the time of the stopping of the movement of the carriage device 2. In addition, a paper discharge roller which sends out the recording medium W while performing slip rotation may also be provided on the downstream side of the platen 17.

The medium supply section 4 serves as a supply source of the recording medium W, in which the recording medium W to be provided for drawing is set. As the form of the recording medium W which is used in this embodiment, any form such as a roll form or a cut sheet form is acceptable, and although it is not particularly shown, with respect to the recording medium W of the former form, paper feed is performed in a roll-to-roll manner, whereas with respect to the recording medium W of the latter form, paper feed is performed one by one from a paper cassette by a paper feed roller. In addition, as the recording medium W, a medium composed of a material such as paper (plain paper, glossy paper or the like), cloth (nonwoven fabric), resin, metal, or glass can be applied.

The ink supply section 5 is constituted by a plurality of ink packs 5a, in each of which colored or colorless ink is enclosed, and each ink pack 5a is connected to each recording head 30 through an ink supply flow path (not shown). Ink of each color is supplied to each recording head 30 through each ink supply flow path by applying pressure (atmospheric pressure) to each ink pack 5a from the outside. Also, each ink supply flow path and each recording head 30 are covered by film heaters (not shown) which heat ink that flows in each ink supply flow path. Ink of each color is supplied to each recording head 30 in a state where the ink is heated by the film heater, thereby being adjusted to a given viscosity.

In addition, the ultraviolet cure type ink is classified broadly into radical polymerization-system ink which contains a radical polymerizable compound as a polymerizable compound and cation polymerization-system ink which contains a cation polymerizable compound as the polymerizable compound. However, in this embodiment, any of them may be used. Also, the ultraviolet cure type ink which is used in this embodiment is ink of ten colors, cyan (C), magenta (M), yellow (Y), black (K), orange (Or), green (Gr), light magenta (LM), light cyan (LC), white (W), and clear (CL). However, a color (hue) and the number of colors are not to be limited to these.

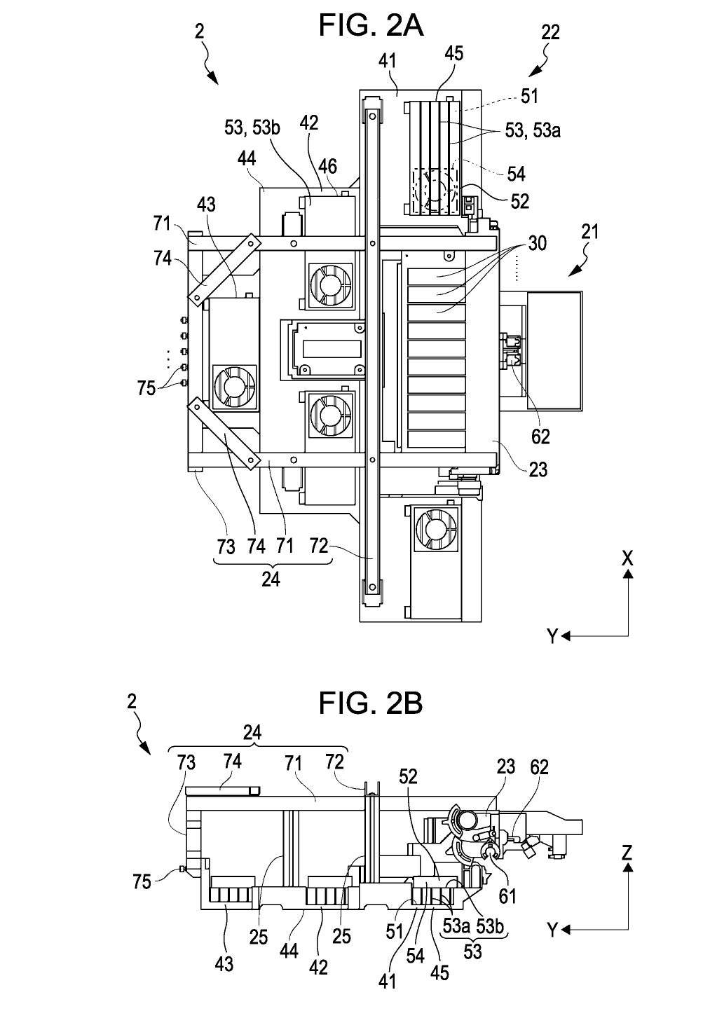

Subsequently, the carriage device 2 will be described in detail with reference to FIGS. 2A to 6C. As shown in FIGS. 2A and 2B, the carriage device 2 includes the head unit 21 which discharges ink onto the recording medium W, the light curing unit 22 which cures the ink landed on the recording medium W, a carriage base 23 which is slidably supported on the first guide shaft 13, a support frame 24 which spans to the second guide shaft 14 and the carriage base 23 and slidably supported on the second guide shaft 14, and a plurality of strut members 25 for suspending the light curing unit 22 from the support frame 24. The carriage device 2 faces the recording medium W fixed onto the platen 17, discharges ink from the head unit 21 onto the recording medium W while reciprocating in the X-axis direction by the head moving mechanism 11, and performs curing of the ink landed on the recording medium W by the light curing unit 22.

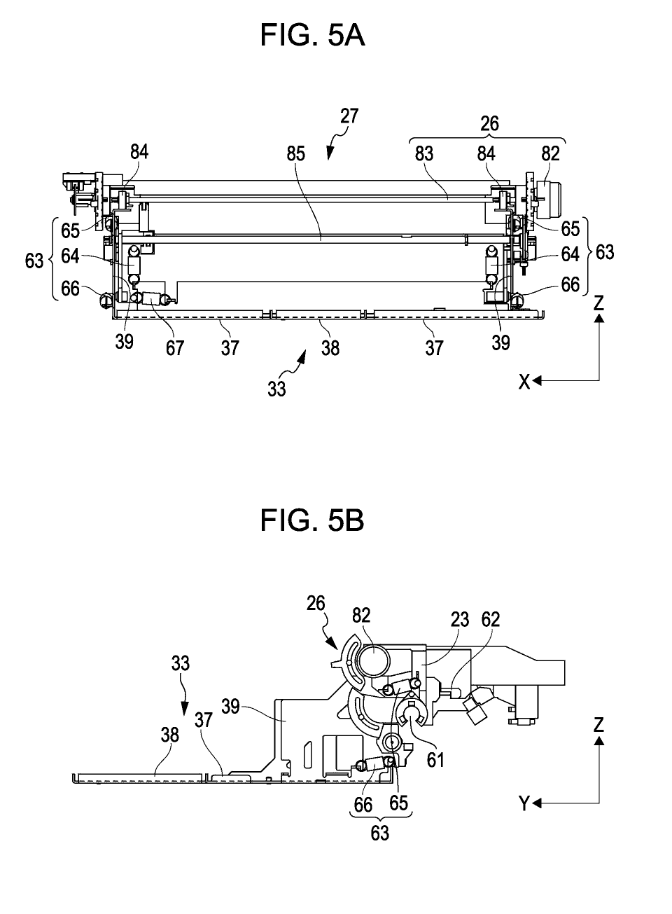

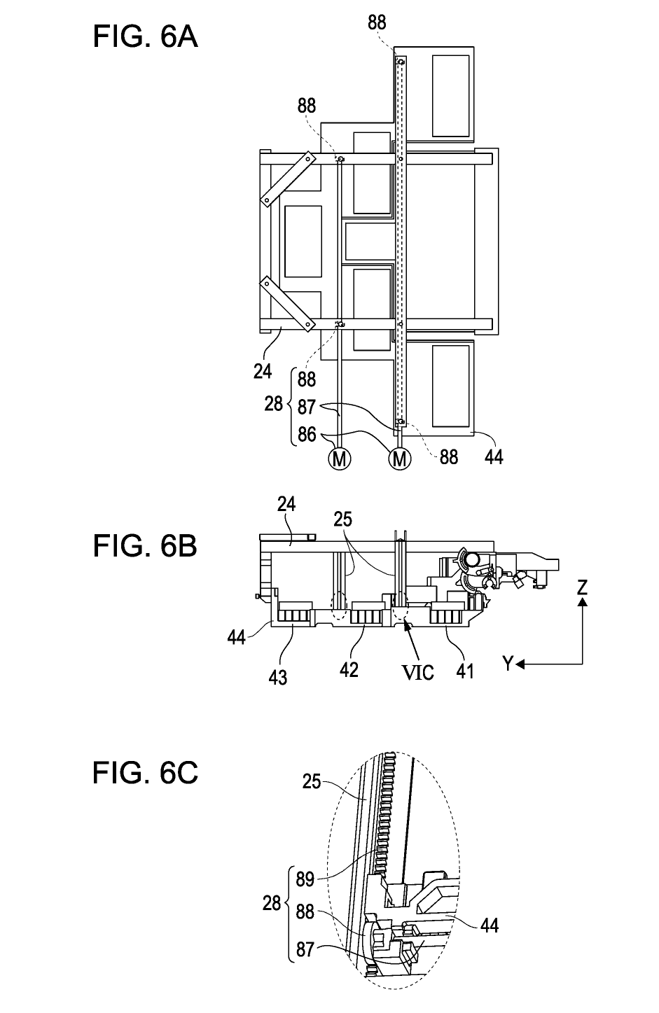

Also, the carriage device 2 further includes a head gap adjustment section 26 (refer to FIGS. 5A and 5B) which adjusts the gap between the head unit 21 and the recording medium W, a parallelism adjustment section 27 (refer to FIGS. 5A and 5B) which adjusts a roll angle of the head unit 21 (parallelism between the head unit and the recording medium W), and a light gap adjustment section 28 (refer to FIGS. 6A to 6C) which adjusts the gap between the light curing unit 22 and the recording medium W.

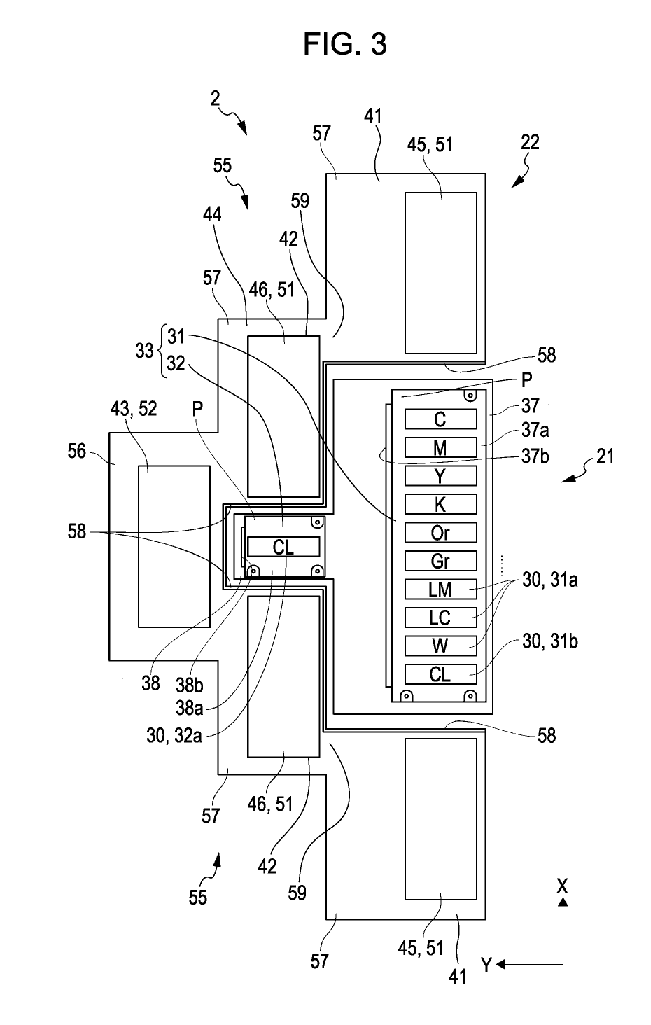

As shown in FIGS. 2A, 2B, and 3, the head unit 21 includes a first recording section 31 having a plurality of recording heads 30 which discharge colored and colorless inks onto the recording medium W, a second recording section 32 having one recording head 30 (a second recording head 32a) which discharge an arbitrary ink onto the recording medium W, and a recording carriage 33 on which the first recording section 31 and the second recording section 32 are divided in the Y-axis direction and mounted.

As shown in FIGS. 4A and 4B, the recording head 30 is to discharge ink in a so-called ink jet method and includes a pump portion 34 which is connected to the above-mentioned ink supply flow path, thereby being supplied with ink, and a nozzle plate 35 connected to the pump portion 34. Two nozzle rows NL are arranged parallel to each other in a nozzle face of the nozzle plate 35, and each nozzle row NL is composed of a number of nozzle orifices 36 arranged at equal pitches. In addition, the number of nozzle rows NL and the number of nozzle orifices 36 are arbitrary. Also, the pump portion 34 is formed in a duplex state so as to correspond to each nozzle row NL. The above-mentioned control section 6 is connected to the recording head 30 through a flexible flat cable (not shown), and a driving waveform outputted from the control section 6 is applied to a piezoelectric element (not shown) of the pump portion 34, so that ink is discharged from each nozzle orifice 36.

As shown in FIGS. 2A, 2B, and 3, the first recording section 31 is constituted being fixed to a first head plate 37a in a state where ten recording heads 30 are arranged in one row at equal intervals in the X-axis direction with the nozzle rows NL faced in the Y-axis direction. The ten recording heads 30 mounted on the first recording section 31 are disposed such that a plurality of first color recording heads 31a which discharge colored (C, M, Y, K, Or, Gr, LM, LC, and W) ink and a single first colorless recording head 31b which discharges colorless (CL) ink are arranged in the X-axis direction. In this embodiment, inks of C, M, Y, K, Or, Gr, LM, LC, W, and CL in order from the upper end in FIG. 3 are introduced (supplied) into the recording heads 30 (each of the first color recording heads 31a, and the first colorless recording head 31b), so that each recording head 30 discharges ink of each color. In addition, the number of pieces of the recording heads 30 is arbitrary, and the order of the colors of ink which is supplied is also arbitrary.

On the other hand, the second recording section 32 is constituted by a single recording head 30 (hereinafter referred to as a second recording head 32a) fixed to a second head plate 38a with the nozzle rows NL faced in the Y-axis direction. To the second recording head 32a, colorless (CL) ink is supplied. In addition, the number of pieces of the second recording heads 32a is arbitrary. However, although the details will be described later, considering the cantilever support of the recording carriage 33, the suppression of generation of mist or the like, it is preferable that the number of second recording heads be smaller than the number of first recording heads which are mounted on the first recording section 31, and one or two would be optimal. Also, as the colorless ink which is supplied to the second recording head 32a, the same ink as that supplied to the first colorless recording head 31b is used. However, ink which is different in viscosity, curing characteristic, gloss in a cured state or the like may also be used.

The recording carriage 33 is integrally formed by a first head holding portion 37 formed into a rectangle having a long side in the X-axis direction, a second head holding portion 38 formed into a square smaller than the first head holding portion 37, and a pair of upright portions 39 (refer to FIGS. 5A and 5B) provided in an upright manner at both ends in the X-axis direction of the first head holding portion 37. The second head holding portion 38 is formed so as to protrude from the center in the X-axis direction toward the downstream side in the Y-axis direction of the first head holding portion 37. That is, the recording carriage 33 is formed in a stairway pattern in a plane.

In the first head holding portion 37, a first head opening 37b, which the first head plate 37a that positions and fixes the plurality of first color recording heads 31a and the first colorless recording head 31b faces, is formed so as to penetrate in the thickness direction (a Z-axis direction). In the same way, in the second head holding portion 38, a second head opening 38b, which the second head plate 38a that positions and fixes the second recording head 32a faces, is formed so as to penetrate in the thickness direction. Also, in the vicinity of each of the first head opening 37b and the second head opening 38b, one positioning pin P (a total of three) is provided in an upright manner. Each positioning pin P is fitted into a positioning hole (not shown) of each of the first head plate 37a and the second head plate 38a, so that the first head plate 37a and the second head plate 38a are respectively fixed (three-screw locking) to the first head holding portion 37 and the second head holding portion 38 in a state where they are respectively positioned in the X-axis direction, the Y-axis direction, and a yawing direction. In this manner, the first recording section 31 and the second recording section 32 are divided and mounted on the recording carriage 33, and the nozzle plate 35 (the nozzle face thereof) of each recording head 30 comes face to face with the recording medium W transported onto the platen 17.

The recording carriage 33 is supported in a cantilever manner on the carriage base 23 at the upstream side in the Y-axis direction of the first head holding portion 37, and the downstream side in the Y-axis direction of the second head holding portion 38 becomes a free end. That is, the recording sections are disposed in the order of the recording sections having a smaller number of the mounted recording heads 30 in a direction away from the first guide shaft 13. In this manner, by supporting the head unit 21 in a cantilever manner, it is possible to accurately and easily perform adjustment which is particular to the head unit 21, such as gap adjustment or parallelism adjustment of the head unit 21 with respect to the recording medium W. Moreover, in the head unit 21, since the recording section in which the number of the mounted recording heads 30 is larger is provided on the first guide shaft 13 side, stable movement where influence of inertia is small becomes possible, so that vibration due to inertia at the time of the starting of the movement and the time of the stopping of the movement can be prevented. By this, since shaking or overrunning of the recording carriage 33 can be suppressed, so that a misalignment does not occur in a landing position of ink on the recording medium W, highly-precise image formation (drawing) becomes possible.

As shown in FIGS. 2A, 2B, and 3, the light curing unit 22 includes a first semi-curing section 41 which performs semi-curing of ink discharged from the first recording section 31, a second semi-curing section 42 which performs semi-curing of ink discharged from the second recording section 32, a main curing section 43 which performs main curing of ink discharged from the first recording section 31 and the second recording section 32, and a light curing carriage 44 on which the first semi-curing section 41, the second semi-curing section 42, and the main curing section 43 are mounted.

The first semi-curing section 41 has a pair of first semi-curing portions 45 located at both ends in the X-axis direction of the first recording section 31 and is made so as to face each ink droplet discharged from the first recording section 31 and landed on the recording medium W, in accordance with reciprocating movement in the X-axis direction. In the same way, the second semi-curing section 42 has a pair of second semi-curing portions 46 located at both ends in the X-axis direction of the second recording section 32 and faces each ink droplet landed on the recording medium W by the second recording section 32. The first semi-curing section 41 and the second semi-curing section 42 performs semi-curing of ink droplets landed on the recording medium W, thereby suppressing wetting and spreading of ink droplets on the recording medium W or preventing ink droplets from flowing out at the time of transport of the recording medium W. By this, it is possible to prevent mixing (color mixing) of ink droplets on the recording medium W and it is also possible to align the respective ink droplets in a certain size. In addition, semi-curing as referred to herein means partial curing in regard to ink droplets, refers to a state where the ink droplets are partially cured, but not completely cured, and is a state where the landed ink droplets are cured at the level that the landed ink droplets are not mixed with adjacent ink droplets to such a extent that it is visually favorably compared therewith, and in a state where a surface becomes smooth so as to have gloss to some extent.

Here, colorless ink droplets discharged from the second recording head 32a can form a coat layer D3 (the details will be described later) in which a portion from the surface thereof up to an inside deep position is not cured and which has wetting and spreading and a smooth surface. In addition, it is preferable that irradiance of ultraviolet which is irradiated from the second semi-curing section 42 be appropriately changed in accordance with the curing characteristic of ink which is discharged from the second recording head 32a.

The main curing section 43 is located on the downstream side in the Y-axis direction of the second recording section 32 and faces each ink droplet semi-cured by the first semi-curing section 41 and the second semi-curing section 42, in accordance with the reciprocating movement thereof in the X-axis direction. The main curing section 43 completely cures the inside of the landed ink droplets by light, thereby fixing the ink droplets onto the recording medium W. Therefore, irradiance (illuminance) of the main curing section 43 is set to be higher (stronger) than those of the first semi-curing section 41 and the second semi-curing section 42. The main curing section 43 is provided on the most downstream side of the carriage device 2, and after the drawing of an image has been performed by the first recording section 31 and the second recording section 32, the main curing section performs main curing of ink droplets which form the image. Also, since ink droplets on the recording medium W are already semi-cured, the main curing section 43 can be constituted so as to have relatively low output and be small in size and light in weight.

Each first semi-curing portion 45, each second semi-curing portion 46, and the main curing section 43 are of approximately the same structure and respectively have a light irradiation section 51 constituted by a plurality of LEDs (Light Emitting Diodes) which irradiates ultraviolet, and a cooling section 52 for cooling the light irradiation section 51. The light irradiation section 51 is a so-called LED array in which a plurality of chip type ultraviolet LEDs is disposed in a matrix form (or on a zigzag form), and constitutes a surface light source as a whole. Also, each first semi-curing portion 45, each second semi-curing portion 46, and the main curing section 43 respectively have a width (a length in the Y-axis direction) of approximately the same length as the length of the nozzle row NL of the recording head 30, and their lengths in the X-axis direction are designed such that a given irradiance can be obtained in the relationship with a movement velocity in the X-axis direction.

The cooling section 52 includes a heat sink 53 which comes into close contact with the upper surface of the light irradiation section 51, and a cooling fan 54 which blows wind (air) toward the heat sink 53. The heat sink 53 is of a so-called fin type, and a plurality of upright fins 53a each extends in the X-axis direction and is disposed at equal intervals in the Y-axis direction. The heat sink 53 is covered by a cover 53b, and the cooling fan 54 is fixed to an opening portion formed in the upper surface of the cover 53b. The cooling fans 54 are respectively located on the head unit 21 side, and air blown by each cooling fan 54 is exhausted (heat-exhausted) to the outside along the fins 53a while absorbing heat from the fins 53a of the heat sink 53. By this, since heat generated from each light irradiation section 51 is effectively exhausted, luminescent performance of the light irradiation section 51 is prevented from being lowered due to heat, so that ink can be stably cured by light. In addition, although the details will be described later, exhaust (heat exhaust) from the cooling fan 54 is cut off by a rib 58 provided in an upright manner on the recording carriage 33 side of the light curing carriage 44.

The light curing carriage 44 includes a pair of carriage side portions 55 which are symmetrically located on both sides in the X-axis direction of the recording carriage 33, and a carriage connection portion 56 which connects the pair of carriage side portions 55. Since the light curing carriage 44 is integrally formed by resin in which a reinforcing rib portion is approximately disposed, it can be constituted in lightweight and at a low cost while maintaining sufficient strength, and propagation of heat in the light curing carriage 44 can also be suppressed.

Each of the carriage side portions 55 has two holding portions 57 which hold the first semi-curing portion 45 and the second semi-curing portion 46. The two holding portions 57 are respectively formed into a rectangular shape and connected to each other at a corner portion 59. That is, the carriage side portion 55 is formed in a stairway pattern. Then, a pair of carriage side portions 55 is symmetrically located so as to interpose the recording carriage 33 between both sides in the X-axis direction in a plane and connected to each other by the carriage connection portion 56 at the downstream side in the Y-axis direction. Also, the carriage connection portion 56 is also formed into a rectangular shape and holds the main curing section 43. Therefore, the first and second recording sections 31 and 32 mounted on the recording carriage 33 and the main curing section 43 mounted on the light curing carriage 44 are aligned along the Y-axis direction at the center in the X-axis direction. That is, in order from the upstream side in the Y-axis direction, the first recording section 31, the second recording section 32, and the main curing section 43 are aligned on the same central line. Therefore, the carriage device 2 having excellent weight balance in the X-axis direction can be constituted and also reciprocated in the X-axis direction at the shortest distance with respect to the width of the recording medium W. By this, stable movement of the carriage device 2 in the X-axis direction becomes possible and also a larger size of the carriage device 2 can be suppressed.

Also, mist (mist-like ink) which is generated when discharging ink from the recording head 30 is often generated from the first recording section 31 on which a larger number of recording heads 30 are mounted. However, in this embodiment, the main curing section 43 is provided at a position separated from the first recording section 31 with the second recording section 32 interposed therebetween. That is, the main curing section 43 is provided at a position separated from a generation source where much mist occurs and furthermore, a position separated from the generation source in the Y-axis direction. Therefore, a risk of attachment of mist to the main curing section 43 can be reduced. By this, the lowering of the luminescent performance (irradiance) of the main curing section 43 is appropriately prevented, so that the main curing of the ink on the recording medium W can be reliably performed, whereby a drawing defect due to ink not curing can be effectively prevented.

Also, since in the second recording section 32, a generation source of mist is small (the single second recording head 32a is provided), a possibility that mist is attached to the main curing section 43 which is located on the downstream side thereof in the Y-axis direction is lowered. Further, as described above, since colorless ink is supplied to the second recording head 32a, mist which is generated is mist of colorless ink. Since colorless mist does not block light (ultraviolet), even if the mist is attached to the main curing section 43, an irradiation amount of ultraviolet is not lowered (or the lowering of the irradiation amount can be minimized). By this, the luminescent performance of the main curing section 43 can be excellently maintained over a long period, so that the frequency of maintenance (wiping and cleaning) can be reduced.

Also, at the side (surface) of each holding portion 57, which comes face to face with the recording carriage 33, the rib 58 is provided in an upright manner so as to cross the holding portion 57 at right angles (refer to FIG. 3). The rib 58 increases a structural strength of the light curing carriage 44 and also functions as a barrier which cuts off heat exhaust by the cooling section 52 of the first semi-curing portion 45 or the second semi-curing portion 46, which is mounted on each holding portion 57. By this, performance degradation due to heat of each recording head (each of the first color recording heads 31a, the first colorless recording head 31b, and the second recording head 32a), each first semi-curing portion 45, and each second semi-curing portion 46 can be effectively prevented.

The light curing carriage 44 is disposed outside the recording carriage 33 at a given interval, and the sides (surfaces) where the light curing carriage 44 and the recording carriage 33 confront each other are complementarily formed. That is, the light curing carriage 44 is provided so as to cover the recording carriage 33 from the downstream side in the Y-axis direction, thereby being formed in a V-shaped stairway pattern, and macroscopically, the recording carriage 33 and the light curing carriage 44 are constituted into a triangular shape disposed such that one side follows the carriage base 23 (or the first guide shaft 13) (refer to FIGS. 1A, 1B, 2A, and 2B). In this manner, since the recording carriage 33 and the light curing carriage 44 are disposed being physically separated without coming into contact with each other, heat generated from the first semi-curing section 41, the second semi-curing section 42, and the main curing section 43, which are mounted on the light curing carriage 44, is not propagated to the recording carriage 33 (and each recording head 30). Therefore, a change in the discharging amount of each ink, distortion of the recording carriage 33 or the like can be prevented from occurring due to the influence of heat. By this, a problem such as a misalignment of a landing position of each ink on the recording medium W can be prevented, so that highly-precise ink discharging can be performed. In addition, although the details will be described later, the light curing carriage 44 (the light curing unit 22) is suspended from and supported on the support frame 24 through a plurality of strut members 25 distributed over the area of the light curing unit 22.

Also, in the light curing carriage 44 (the carriage side portion 55), since the holding portion 57 and the holding portion 57 are connected to each other at the corner portion 59, a heat transfer area between the holding portions 57 is very small and propagation of heat between the holding portions 57 can also be suppressed. By this, since mutual thermal influence of the first semi-curing section 41, the second semi-curing section 42, and the main curing section 43 can be eliminated, the luminescent performance of each light curing section is not lowered. Therefore, the curing of ink is excellently performed, so that drawing quality of an image can be excellently maintained.

A shown in FIGS. 2A, 2B, 5A, and 5B, the carriage base 23 is a member made of resin and includes a shaft engagement portion 61 which is slidably engaged with the first guide shaft 13, the belt fixing portion 62, in which the timing belt 16c is sandwiched and fixed thereto, and a cantilever support mechanism 63 which supports the head unit 21 in a cantilever manner.

The shaft engagement portion 61 is recessed into an approximately circular shape complementary to the shape of the first guide shaft 13 (a semi-circular shaft) and provided so as to cover the first guide shaft 13 from above, thereby being slidably engaged with the first guide shaft (refer to FIG. 2B). Also, the belt fixing portion 62 is provided so as to protrude to the upstream side in the Y-axis direction at the center in the X-axis direction of the carriage base 23 and pinches and supports the timing belt 16c (refer to FIG. 1A). Then, the carriage device 2 is pulled to the timing belt 16c and reciprocates in the X-axis direction by the driving of the servomotor 15.

Also, as shown in FIGS. 5A and 5B, the cantilever support mechanism 63 supports in a cantilever manner the head unit 21 at the downstream side in the Y-axis direction. The cantilever support mechanism 63 includes a pair of lifting springs 64 which lifts up the head unit 21, and a pair of first attracting springs 65 and a pair of second attracting springs 66, which attract the head unit 21 to the carriage base 23 side.

Each of a pair of lifting springs 64 is engaged at one end thereof with each of hooks provided at both ends in the X-axis direction of the first head holding portion 37 and at the other end with each of protrusions provided so as to protrude at both ends in the X-axis direction of the carriage base 23. Also, each of a pair of first attracting springs 65 is engaged at one end thereof with each of hooks provided at the upper end portions of both ends in the X-axis direction of the upright portion 39 and at the other end with each of hooks provided at the upper sides of both side surfaces in the X-axis direction of the carriage base 23. In the same way, each of a pair of second attracting springs 66 is engaged at one end thereof with each of hooks provided at the lower end portions of both ends in the X-axis direction of the upright portion 39 and at the other end with each of hooks provided at the lower sides of both side surfaces in the X-axis direction of the carriage base 23.

Then, the head unit 21 is lifted up by a pair of lifting spring 64 and also pressed (pushed down) by the head gap adjustment section 26 (the details will be described later). Also, the head unit 21 is attracted to the upstream side in the Y-axis direction by a pair of first attracting springs 65 and a pair of second attracting springs 66 and also pressed by the parallelism adjustment section 27 (the details will be described later). By this, the head unit 21 is supported on the carriage base 23 in a cantilever state. In addition, an X-axis attracting spring 67 which performs position adjustment in the X-axis direction of the head unit (the recording carriage 33) is provided below the lifting spring 64 on the left side in FIG. 5A.

As shown in FIGS. 2A and 2B, the support frame 24 includes a pair of beam members 71, each of which is connected at an end portion on one side thereof to the upper end surface of the carriage base 23 and extends to the downstream side in the Y-axis direction, a girder member 72 orthogonally connected and fixed to the upper surface of each beam member 71, and a wall member 73 suspended from the other ends of the pair of beam members 71. Also, a pair of braces 74 is connected to the upper surfaces of each beam member 71 and the wall member 73, thereby increasing strength of the support frame 24 as a structural body. On the face of the wall member 73 on the downstream side in the Y-axis direction, a plurality (five pieces) of rollers 75 which comes into rolling contact with the second guide shaft 14 is rotatably supported side by side at equal intervals in the X-axis direction in a cantilever manner. In addition, the beam member 71, the girder member 72, and the brace 74 are respectively constituted by a channel material made of aluminum alloy, and the wall member 73 is constituted by resin. Also, the number of the beam members 71 which is disposed, the number of the girder members 72 which is disposed, and the number of the braces 74 which is disposed are arbitrary.

Each of a plurality (four pieces) of strut members 25 is connected at one end thereof to each of both ends of the girder member 72 and the slightly downstream side from the center in the Y-axis direction of each beam member 71 and at the downwardly extended other end thereof to the light curing carriage 44. That is, the light curing carriage 44 (the light curing unit 22) is suspended and supported by four strut members 25 so as to hang from the support frame 24. Four strut members 25 are respectively connected to the light curing carriage 44 in the vicinities of each first semi-curing portion 45 and each second semi-curing portion 46. The light curing carriage 44 is supported by the strong support frames 24 through four strut members 25, so that the light curing carriage 44 can be effectively prevented from being distorted (thermally deformed) due to heat generated from each first semi-curing portion 45 and each second semi-curing portion 46. By this, it is possible to maintain the light curing unit 22 at a set flatness (position). In addition, although the details will be described later, the light gap adjustment section 28 is constituted at each strut member 25. Also, the number of strut members 25 which are disposed is arbitrary.

In this manner, the light curing unit 22 is slidably supported at both sides by the first guide shaft 13 and the second guide shaft 14 through the carriage base 23 and the support frame 24 (a plurality of strut members 25), and the head unit 21 and the light curing unit 22 are located between the first guide shaft 13 and the second guide shaft 14 (refer to FIGS. 1A and 1B). That is, the carriage device 2 is stably supported while the overall weight thereof is dispersed to the first guide shaft 13 and the second guide shaft 14. By this, the whole of the carriage device 2 can move in the X-axis direction while maintaining a stable position without vibrating at the time of the starting of the movement and the time of the stopping of the movement.

Also, since the head unit 21 and the light curing unit 22 are integrated with each other so as to constitute the carriage device 2 and can be simultaneously moved in the X-axis direction, an image drawing operation and a semi-curing operation (and a main curing operation) can be continuously performed at the time of the same movement. By this, the image drawing and the curing can be efficiently performed in a short time. Further, since it is possible to make the head unit 21 and the light curing unit 22 face the entire area (all regions to be recorded) of a recording face F of the recording medium W by the movement of the carriage device 2, the head unit 21 and the light curing unit 22 can be constituted as a small size, and therefore, the whole of the carriage device 2 can be made into a small size.

As shown in FIGS. 5A and 5B, the head gap adjustment section 26 includes an adjustment gear 82 (a speed reduction gear train composed of planetary gears) which is connected to an adjustment motor (not shown) through a gear train 81 (refer to FIG. 1B), a gap adjustment shaft 83 to which the rotation from the adjustment gear 82 is transmitted, and a pair of eccentric cams 84 connected to the gap adjustment shaft 83.

In this gap adjustment, first, if the carriage device 2 moves to the home position H, a driving shaft of the adjustment motor is connected to the gear train 81 and the gear train 81 rotates, thereby being engaged with the adjustment gear 82. Then, by the driving of the adjustment motor, each eccentric cam 84 rotates through the gap adjustment shaft 83 supported on the carriage base 23 so as to be able to rotate about an axis. Each eccentric cam 84 comes into contact with the upper end surface of each upright portion 39 of the recording carriage 33 (the first head holding portion 37 thereof). Therefore, in accordance with the rotation of each eccentric cam 84, the recording carriage 33 (the head unit 21) is pushed down against each lifting spring 64 of the above-described cantilever support mechanism 63 or lifted up by each lifting spring 64, thereby performing up-and-down movement (ascent and descent). Therefore, it is possible to appropriately change the gap between the head unit 21 (each recording head 30) and the recording medium W in accordance with the thickness or the type of the recording medium W (infiltration or non-infiltration of ink or the like). By this, optimum ink discharging can be performed, so that the drawing of a highly-precise image can be performed on the recording medium W. In addition, a configuration is also acceptable in which the adjustment motor is omitted and the adjustment can be manually performed, and further, a configuration may also be made such that fine adjustment of a pitch angle can be performed by making the respective eccentric cams 84 be able to be separately rotated.

As shown in FIGS. 5A and 5B, the parallelism adjustment section 27 includes an eccentric shaft 85 which comes into contact with the upstream side (rear side) in the Y-axis direction of each upright portion 39. The eccentric shaft 85 is rotatably supported on the carriage base 23, and in accordance with the rotation of the eccentric shaft 85, the recording carriage 33 (the head unit 21) is pressed out against each first attracting spring 65 and each second attracting spring 66 of the above-described cantilever support mechanism 63 or attracted by each first attracting spring 65 and each second attracting spring 66, thereby rotating in a rolling direction. In this way, it is possible to maintain the head unit 21 (each recording head 30) in a parallel fashion and also make parallelism of each recording head 30 uniform. By this, since each recording head 30 (each of the first color recording heads 31a, the first colorless recording head 31b, and the second recording head 32a) can face the recording medium W in a parallel fashion with an appropriate gap, optimum ink discharging becomes possible.

As shown in FIGS. 6A to 6C, the light gap adjustment section 28 includes two adjustment rotating shafts 87 to which the rotation from a geared motor 86 is transmitted, two sets of paired pinions 88 connected to the adjustment rotating shafts 87, a plurality of racks 89, with which each pinion 88 is engaged, and a plurality of guide mechanisms (not shown) which maintains an engagement state of each rack 89 with each pinion 88 and guides up-and-down movement (ascent and descent).

Each rack 89 is formed at the strut member 25, and each adjustment rotating shaft 87 is supported so as to be able to rotate with respect to the light curing carriage 44 (refer to FIG. 6C). In this light gap adjustment, if the carriage device 2 moves to the home position H, a driving shaft of each geared motor 86 is connected to each adjustment rotating shaft 87. Then, a pair of pinions 88 (refer to FIG. 6A) which is arranged in the X-axis direction at the upstream side in the Y-axis direction rolls along each rack 89 by the driving of the geared motor 86 connected to one end of the adjustment rotating shaft 87. A pair of pinions 88 which is arranged in the X-axis direction at the downstream side in the Y-axis direction is also the same. In this way, the light curing carriage 44 is moved upward or downward (ascends or descends) along each rack 89 by the rotation of each pinion 88. Therefore, it is possible to appropriately change the gap between the light curing unit 22 and the recording medium W in accordance with the thickness or the type of the recording medium W and appropriately cure ink droplets on the recording medium W by irradiating light of optimum intensity (irradiance) in accordance with the type or the like of ink or the type or the like of the recording medium W. In addition, the light gap adjustment section 28 may also be provided above (or midway in the Z-axis direction) each strut member 25. Also, a configuration is also acceptable in which the adjustment rotating shafts 87 are omitted and each pinion 88 is individually rotated. Furthermore, each strut member 25 may also be made into a telescopically sliding structure in which an inside strut and an outside strut are thread-engaged with each other, whereby ascent and descent are performed by rotating a screw (a lead screw mechanism), or each strut member 25 may also be made so as to slide by using a cylinder-piston structure.

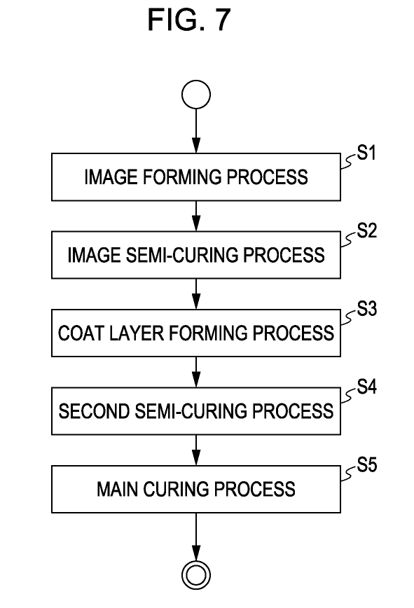

Next, an image forming method which is controlled by the control section 6 of the ink jet recording apparatus 1 related to this embodiment will be described with reference to FIGS. 7, 8A to 8E, and 9A to 9C. In the following explanation, colored ink of nine colors except colorless (CL) ink which is supplied to the first recording section 31 is referred to as “first colored ink 91”, and the colorless ink is referred to as “first colorless ink 92”. In the same way, colorless ink which is supplied to the second recording section 32 is referred to as “second ink 93”. Then, the first colored ink 91 is supplied to a plurality of first color recording heads 31a of the first recording section 31 and the first colorless ink 92 is supplied to the first colorless recording head 31b. Also, the second colorless ink 93 is supplied to the second recording head 32a of the second recording section 32. Further, prior to an image forming operation, the carriage device 2 is located at the home position H, and the gap adjustment and the parallelism adjustment of the head unit (each recording head 30) with respect to the recording medium W (the recording face F thereof) and the gap adjustment of the light curing unit 22 are performed by the head gap adjustment section 26, the parallelism adjustment section 27, and the light gap adjustment section 28.

As shown in FIG. 7, this image forming method includes an image forming process S1 which forms a visible image D1 and a non-visible image D2 filling up a portion other than the visible image D1 on the recording medium W by discharging the first colored ink 91 and the first colorless ink 92, an image semi-curing process S2 which performs semi-curing of the first colored ink 91 constituting the visible image D1 and the first colorless ink 92 constituting the non-visible image D2 by the first semi-curing section 41, a coat layer forming process S3 which forms a coat layer D3 on the visible image D1 and the non-visible image D2 by discharging the second ink 93, a second curing process S4 which performs semi-curing of the second ink 93 constituting the coat layer D3 by the second semi-curing section 42, and a main curing process S5 which performs main curing of the visible image D1, the non-visible image D2, and the coat layer D3 by the main curing section 43.

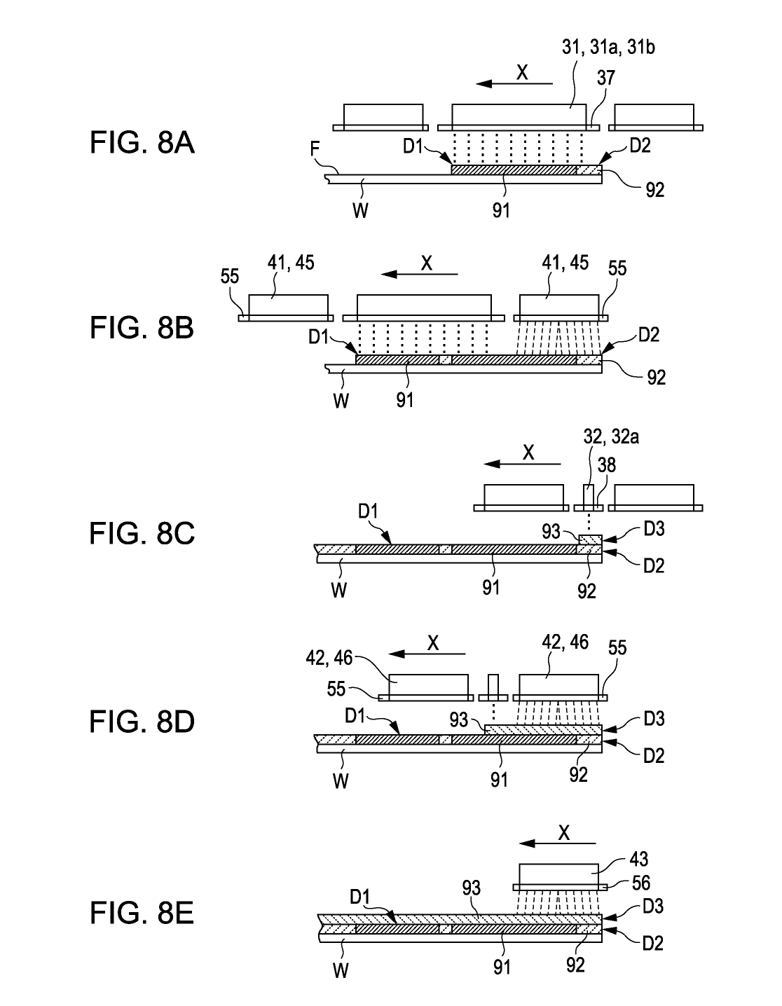

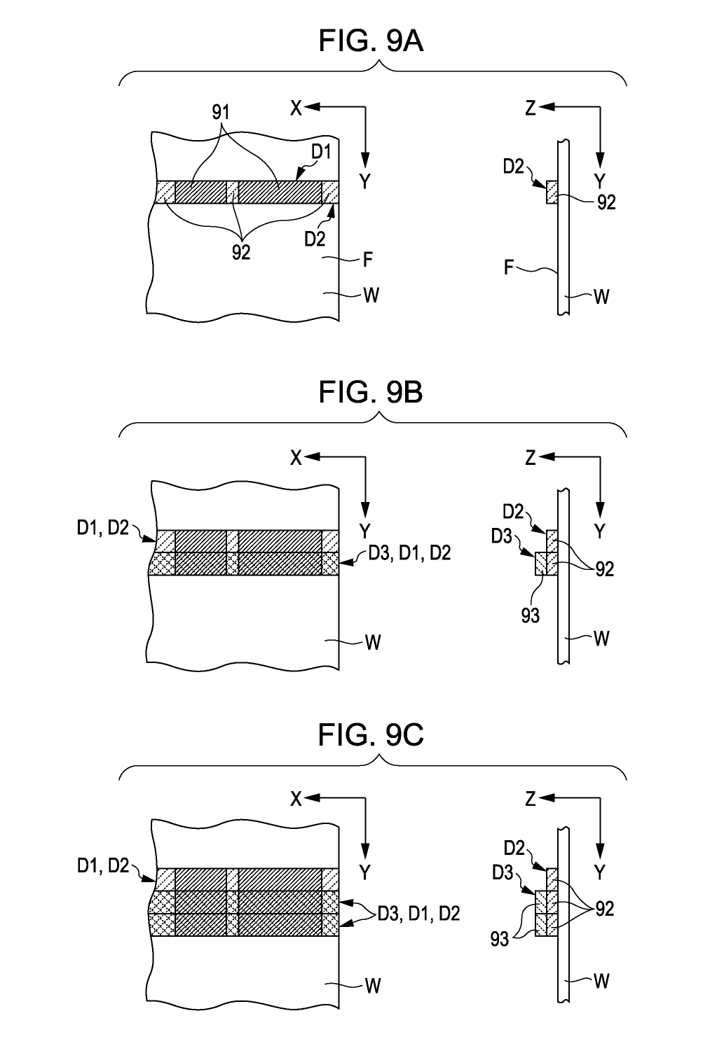

In the image forming process S1 (an image forming operation), the visible image D1 is formed (drawn) by discharging the first colored ink 91 from the first recording section 31 to the recording medium W transported to a position facing the first recording section 31, on the basis of image data, while reciprocating the carriage device 2 in the X-axis direction. At the same time, in parallel with this, the non-visible image D2 is drawn by discharging the first colorless ink 92 to a portion where the first colored ink 91 is not discharged in the image data, that is, a background portion of the visible image D1 (refer to FIG. 8A). The recording face F of the recording medium W, in which the visible image D1 and the non-visible image D2 are formed in this manner, is fully covered by the first colored ink 91 and the first colorless ink 92 (refer to FIG. 9A). Therefore, unevenness due to the existence or nonexistence of the landing of ink does not occur on the recording medium W. In addition, in this embodiment, at the time of reciprocation movement (at the time of forward movement and the time of backward movement), discharging (drawing) of each ink from the head unit 21 is performed. However, a configuration may also be made such that the drawing is performed at only at either the time of the forward movement or the time of the backward movement.

In the image semi-curing process S2 (an image semi-curing operation), semi-curing of the first colored ink 91 and the first colorless ink 92 (ink droplets thereof) landed on the recording medium W in the image forming process S1 is performed while reciprocating the carriage device 2 in the X-axis direction. For example, in a case where the visible image D1 and the non-visible image D2 are drawn at the time of the forward movement of the carriage device 2, the forward movement is performed while irradiating ultraviolet by using the first semi-curing portion 45 on the downstream side (the right side in FIG. 8B) in the forward movement direction (refer to FIG. 8B). That is, immediately after the discharging of the first colored ink 91 and the first colorless ink 92, semi-curing can be performed. In this case, since semi-curing of each ink droplet on the recording medium W can be continuously performed in accordance with the movement for the drawing, the visible image D1 and the non-visible image D2 can be formed (drawn and semi-cured) in a short time.

Furthermore, it is also possible to perform only the drawing at the time of the forward movement and perform the semi-curing by using the first semi-curing portion 45 on the downstream side in the backward movement direction at the time of the backward movement. In this case, since it takes time before ultraviolet is irradiated, each ink droplet on the recording medium W wets and spreads widely, so that a smooth surface in which unevenness is further suppressed is obtained. In this manner, it is possible to control time before the semi-curing of the first colored ink 91 and the first colorless ink 92, so that it is possible to arbitrarily set surface roughness of each of the visible image D1 and the non-visible image D2. Also, since by performing the semi-curing, not only color mixing of each ink is prevented, but also a size of each ink droplet is made uniform, unevenness in the surfaces of the visible image D1 and the non-visible image D2 is suppressed, thereby allowing the surfaces to be make flat. By this, it is possible to form a smooth coat layer D3 in a subsequent process.

If the image forming process S1 and the image semi-curing process S2 are finished, a portion of the recording medium W, in which the visible image D1 and the non-visible image D2 are drawn, is moved to the downstream side in the Y-axis direction up to a position facing the second recording section 32, by the medium feed mechanism 12, and again fixed onto the platen 17. Then, a coat layer forming process S3 is continuously performed with respect to the drawn visible and non-visible images D1 and D2.

In the coat layer forming process S3 (a coat layer forming operation), a transparent coat layer D3 for protecting the visible image D1 and the non-visible image D2 and also providing gloss is formed by discharging the second ink 93 from the second recording section 32 while reciprocating the carriage device 2 in the X-axis direction (refer to FIG. 8C). As described above, the recording medium W (the recording face F) is fully covered by the semi-cured visible and non-visible images D1 and D2, so that unevenness due to the ink droplets does not occur in the upper face of the recording medium W. By this, since the second ink 93 is discharged onto a foundation (the visible image D1 and the non-visible image D2) having no unevenness, the coat layer D3 having no unevenness and having excellent gloss can be formed. In addition, similarly to the image forming process S1, also in the coat layer forming process S3, the discharging of the second ink 93 is performed at the time of the reciprocating movement(at the time of the forward movement and the time of the backward movement). However, a configuration may also be made such that the coat layer forming operation is performed at only at either the time of the forward movement or the time of the backward movement.

In the second semi-curing process S4 (a coat layer semi-curing operation), similarly to the image semi-curing process S2, semi-curing of the second ink 93 landed on the visible image D1 and the non-visible image D2 in the coat layer forming process S3 is performed by using the second semi-curing portion 46 while reciprocating the carriage device 2 in the X-axis direction (refer to FIG. 8D). By this, the semi-curing of the second ink 93 can be performed being accompanied by the coat layer forming operation either continuously or after a period of time, so that it is possible to adjust surface roughness of the coat layer D3. In addition, since the visible image D1 (the first colored ink 91) and the non-visible image D2 (the first colorless ink 92) have been semi-cured, color mixing of the second ink 93 does not occur.

As described above, since the irradiance of the ultraviolet which is irradiated from the second semi-curing portion 46 is set to be lower than that from the first semi-curing portion 45, in the second semi-curing process S4, each ink droplet of the second ink 93 is semi-cured in a state where wetting and spreading easily occur. By this, the coat layer D3 can have a smooth surface having no unevenness on the visible image D1 and the non-visible image D2 and have a more beautiful gloss. Also, a configuration is also acceptable in which arbitrary gloss adjustment such as matt tone (matte) or gloss tone (glossy) is performed by controlling the irradiance of the ultraviolet, thereby adjusting the wetting and spreading of the second ink 93.

If the coat layer forming process S3 and the second semi-curing process S4 are finished, a portion of the recording medium W, in which the visible image D1, the non-visible image D2, and the coat layer D3 are formed, is moved to the downstream side in the Y-axis direction up to a position facing the main curing section 43, by the medium feed mechanism 12, and again fixed onto the platen 17. Then, a main curing process S5 is continuously performed with respect to the formed visible and non-visible images D1 and D2 and coat layer D3.

In the main curing process S5 (a main curing operation), main curing of the visible image D1, the non-visible image D2, and the coat layer D3 is performed by the main curing section 43 while reciprocating the carriage device 2 in the X-axis direction (refer to FIG. 8E). In this case, since the visible image D1, the non-visible image D2, and the coat layer D3 are already semi-cured, it is possible to shorten time for the main curing operation. Also, since the visible image D1, the non-visible image D2, and the coat layer D3 are completely cured, even if the drawn recording media W are stacked one by one, there is no collapse of a drawing result (an image) or ink stains do not show up.

In addition, when the coat layer forming process S3 and the second semi-curing process S4 are performed, at the upstream side in the Y-axis direction, the image forming process S1 and the image semi-curing process S2 are performed in parallel (refer to FIG. 9B). In the same way, when the main curing process S5 is performed, at the upstream side in the Y-axis direction, the coat layer forming process S3 and the second semi-curing process S4, and the image forming process S1 and the image semi-curing process S2 are respectively performed in parallel (refer to FIG. 9C). That is, in the ink jet recording apparatus 1 of this embodiment, (A) the drawing and the semi-curing of the visible image D1 and the non-visible image D2, (B) the formation and the semi-curing of the coat layer D3, and (C) the main curing of the visible image D1, the non-visible image D2, and the coat layer D3 can be performed in parallel and continuously in the same main scanning (the movement in the X-axis direction). By this, it is possible to efficiently form the visible image D1, the non-visible image D2, and the coat layer D3 on the recording medium W.

In addition, the above-described image forming method (the procedure thereof) is one example, and it is preferable if each process is performed at least at any of the time of the forward movement and the time of the backward movement of the carriage device 2. For example, a configuration may also be made such that at the time of the forward movement of the carriage device 2, the image forming process S1, the image semi-curing process S2, and the main curing process S5 are performed, and at the time of the backward movement, the coat layer forming process S3 and the second semi-curing process S4 are performed.

According to the above-described configuration, since vibration due to inertial at the time of the start of the movement and the time of the stopping of the movement of the carriage device 2 can be effectively prevented, shaking or overrunning of the recording carriage 33 (each recording head 30) is suppressed, so that highly-precise image formation having no misalignment in a landing position of each ink on the recording medium W becomes possible.

### Second Embodiment

A curing method of the ultraviolet cure type ink can be controlled not only by the irradiance (illuminance) of ultraviolet which is received, but also by a cumulative amount of the received ultraviolet (ultraviolet receiving time).

Therefore, the time of ultraviolet irradiation to the second ink 93 on the recording medium W may also be shortened by making the length of the X-axis direction of each second semi-curing portion 46 shorter (smaller) than that of each first semi-curing portion 45. That is, a cumulative amount of ultraviolet that the second ink 93 on the recording medium W receives is reduced by making an area of the light irradiation section 51 in each second semi-curing portion 46 smaller. By this, similarly to the first embodiment, the second ink 93 easily wets and spreads, so that the smooth coat layer D3 can be formed. In addition, conversely, when a high irradiance is required for the curing of the second ink 93, the length of the X-axis direction of each second semi-curing portion 46 may also be made longer than that of each first semi-curing portion 45 (an area of the light irradiation section 51 may also be made larger).

What is claimed is:

1. A carriage device of an ink jet recording apparatus which discharges light cure type ink onto a recording medium while moving along a first guide shaft and a second guide shaft, which are disposed parallel to each other, and cures the discharged ink by light, thereby forming a desired image on the recording medium, the carriage device comprising:
a head unit having a recording head which discharges the ink onto the recording medium and a recording carriage on which the recording head is mounted;
a light curing unit having a plurality of light curing sections which cures the ink on the recording medium by light and a light curing carriage on which the plurality of light curing sections are mounted;
a carriage base slidably supported on the first guide shaft; and
a support frame having one end fixed to the carriage base and the other end slidably supported on the second guide shaft,
wherein the head unit is supported in a cantilever manner on the carriage base.

2. The carriage device of the ink jet recording apparatus according to claim 1, wherein the head unit and the light curing unit are disposed between the first guide shaft and the second guide shaft.

3. The carriage device of the ink jet recording apparatus according to claim 2, wherein
a plurality of the recording heads is provided,
the plurality of recording heads are grouped into a plurality of recording sections and mounted on the recording carriage, and
the plurality of recording sections are disposed in the order of the recording sections having a smaller number of the mounted recording heads in a direction away from the first guide shaft.

4. The carriage device of the ink jet recording apparatus according to claim 1, wherein the plurality of light curing sections are located on both outer sides in a movement direction of each of the recording sections.

5. The carriage device of the ink jet recording apparatus according to claim 4, wherein
each of the light curing sections performs semi-curing of the ink to a surface cured state, and
the light curing unit further includes a main curing section which is mounted on the light curing carriage and performs main curing of the ink after the semi-curing.

6. The carriage device of the ink jet recording apparatus according to claim 1, further comprising:
a head gap adjustment section which is interposed between the carriage base and the head unit and adjusts a gap of the head unit with respect to the recording medium; and
a parallelism adjustment section which adjusts parallelism of the head unit with respect to the recording medium.

7. The carriage device of the ink jet recording apparatus according to claim 1, wherein the light curing unit is suspended from and supported on the support frame through a plurality of pieces of strut members distributed over the entire area of the light curing unit.

8. An ink jet recording apparatus comprising:
the carriage device of the ink jet recording apparatus according to claim 1; and
a movement section which moves the carriage device in a main scanning direction along the first guide shaft and the second guide shaft and moves the recording medium in a sub-scanning direction.
